(19) United States
(12) Patent Application Publication
(10) Pub. No.: US 2006/0158606 A1
(43) Pub. Date: Jul. 20, 2006

(54) Eyewear having an aperture for attachment

(76) Inventor: Rayford R. Hudson III, Jackson, MS (US)

Correspondence Address: BUTLER, SNOW, O'MARA, STEVENS & CANNADA PLLC, 6075 POPLAR AVENUE, SUITE 500, MEMPHIS, TN, 38119, US

(21) Appl. No.: 11/334,915

(22) Filed: Jan. 19, 2006

Related U.S. Application Data
(60) Provisional application No. 60/645,096, filed on Jan. 20, 2005.

(51) Int. Cl. G02C 11/08

(52) U.S. Cl. 351/62

(57) ABSTRACT

Eyewear configured to secure to a button attached to clothing is disclosed. The eyewear has (a) a lens frame configured to accommodate lenses and (b) a pair of arms, wherein each arm is attached to opposite ends of the lens frame and includes an end portion configured to secure the lens frame to the wearer of the eyewear, wherein each end portion has a tear-shaped aperture. The tear-shaped aperture is configured to receive a button attached to clothing in order to secure the eyewear to the button of such clothing. A method to attach the eyewear to the button of the clothing is disclosed.

### RELATED APPLICATIONS

THIS APPLICATION CLAIMS PRIORITY TO PROVISIONAL APPLICATION 60/045,096 PURSUANT TO 35 U.S.C. 119.

### STATEMENT REGARDING FEDERALLY SPONSORED RESEARCH OR DEVELOPMENT

NOT APPLICABLE

### REFERENCE A “MICROFICHE APPENDIX”

NOT APPLICABLE

### FIELD OF THE INVENTION

The present invention relates to eyewear that may be attached to clothing. In particular, the present invention relates to eyewear wherein the arms of said eyewear are produced with an aperture in the end portion of each arm in order that the eyewear may be secured to a button of the front of a shirt or blouse.

### BACKGROUND OF THE INVENTION

Individuals who wear eyewear are often challenged with the task of safely and securely storing their eyewear when the eyewear is temporarily not in use. This task is especially applicable for those who wear eyewear which is frequently removed and replaced such as reading glasses and sunglasses. Once removed, eyewear may be placed in a traditional eyewear case and placed in a clothing pocket, a purse, or other handbag. However, this process is burdensome especially if the eyewear is to be removed for a brief period of time. Additionally, eyewear cases are typically large in size and made of a sturdy material making them unsuitable for placing in a clothing pocket. Once removed, eyewear may also be placed in clothing pockets without a case making the eyewear susceptible to falling out resulting in damaged eyewear or lost eyewear. Eyewear placed temporarily on a desk, a reading table, a kitchen counter or any other place is also subject to being lost or damaged. Moreover, eyewear placed in a purse or handbag is often difficult to locate when needed among the various other articles in such purse or handbag.

Many attempts have been made to resolve the challenges associated with safely and securely storing eyewear in a manner which also provides efficient access to the eyewear. One common method of securing eyewear includes attaching a strap to the ends of the eyewear which allows the eyewear to be hung around the wearer's neck when such eyewear is not being used. However, the eyewear strap does not hold the eyewear in a stationary position but allows the eyewear to swing around striking other objects in its way. This movement of the eyewear often impedes and unduly burdens the movement of the wearer as the wearer must protect the eyewear from damage.

Several U.S. patents disclose devices directed to securing eyewear including U.S. Pat. No. 5,860,191 and U.S. Pat. No. 5,551,126. These devices complicate the procedure involved in safely and securely storing eyewear and require the wearer to keep such devices handy at all times.

Accordingly, it would be desirable to provide eyewear which could be conveniently and easily attached to the clothing allowing such eyewear to be easily accessible when needed and to be safely and securely stored when not needed.

### SUMMARY OF THE INVENTION

This invention provides eyewear that may be attached to a button sewn on clothing, including a shirt or a blouse. The invention provides eyewear made of (a) a lens frame configured to accommodate lenses and (b) a pair of arms, wherein each arm is attached to opposite ends of the lens frame and includes an end portion configured to secure the lens frame to the wearer of the eyewear, wherein each end portion has a tear-shaped aperture. The tear-shaped aperture is configured to receive a button attached to clothing in order to secure the eyewear to the button of such clothing.

In the preferred embodiment, the aperture is made of a thread retaining portion and a button insertion portion. The button insertion portion is opposite the thread retaining portion.

This invention further provides a method to attach eyewear to a button attached to clothing by a bundle of threads, wherein said eyewear comprises (a) a lens frame configured to accommodate lenses and (b) a pair of arms, wherein each arm is attached to opposite ends of said lens frame, wherein each said arm includes an end portion configured to secure said lens frame to a wearer of said eyewear, said end portion having an aperture, wherein said aperture is tear-shaped, wherein said aperture comprises a thread retaining portion and a button insertion portion, wherein said button insertion portion is opposite said thread retaining portion, said method comprising: (a) folding said pair of arms in towards the opposite ends of said lens frame; (b) inserting said button attached to clothing into the button insertion portion of said aperture; and (c) allowing said bundle of threads attaching button to clothing to slide into the thread retaining portion of said aperture.

### DETAILED DESCRIPTION OF THE FIGURES

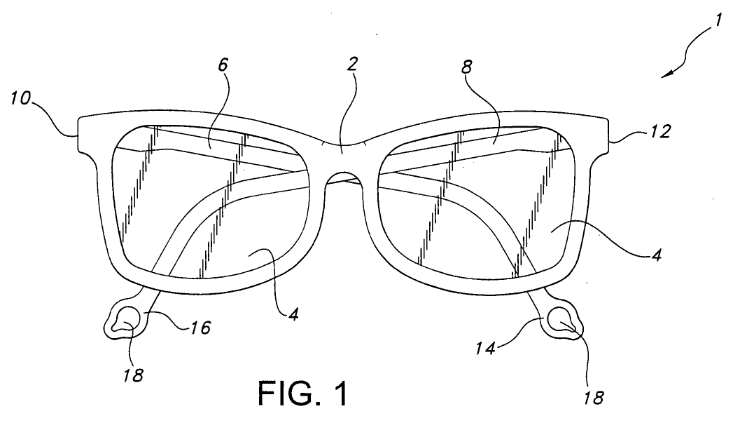

FIG. 1 is a perspective view of eyewear having an aperture for attachment.

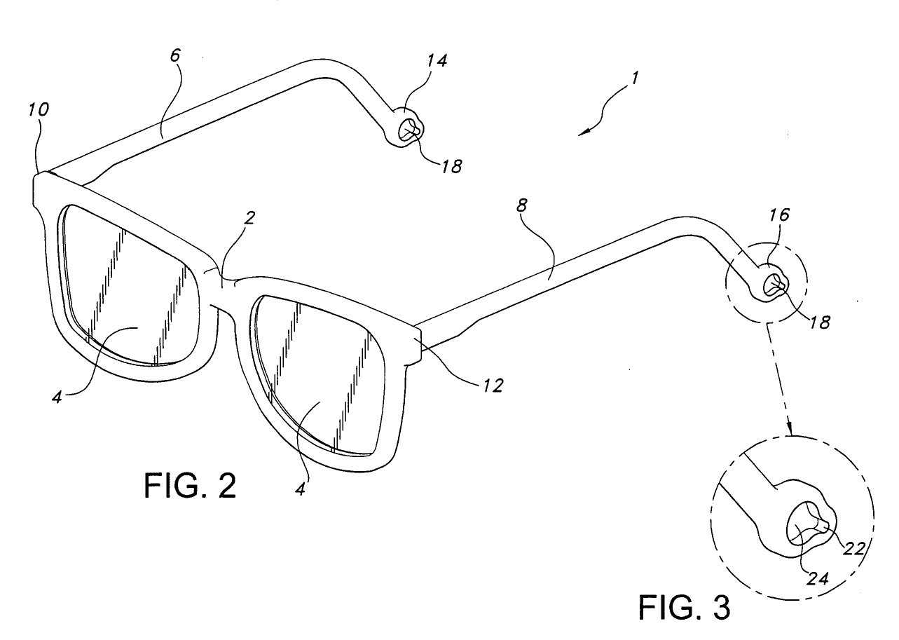

FIG. 2 is a perspective view of eyewear having an aperture for attachment.

FIG. 3 is a perspective view of the aperture.

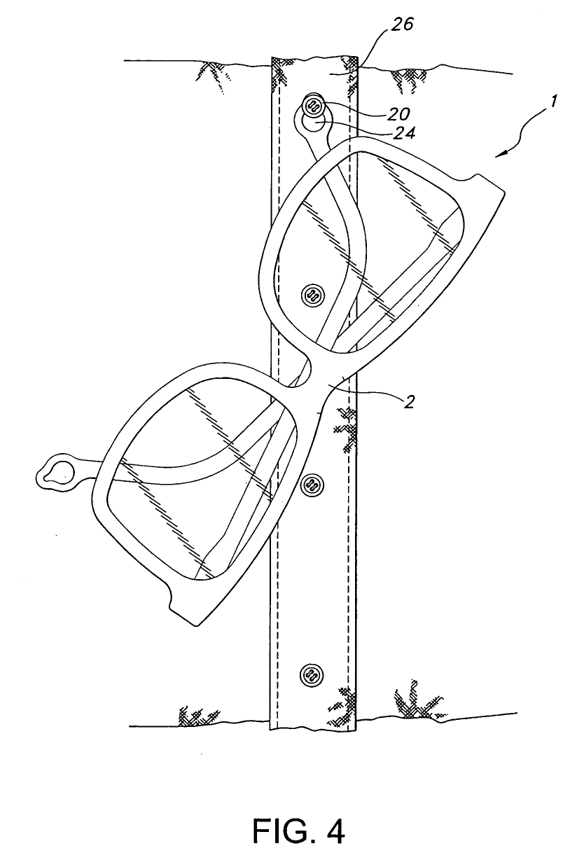

FIG. 4 is a perspective view of the eyewear having an aperture for attachment attached to a button of a shirt.

### DETAILED DESCRIPTION OF THE INVENTION

Referring now to FIGS. 1-2, eyewear 1 has a lens frame 2 configured to accommodate lenses 4. Lens frame 2 may be of any shape as desired by one of skill in the art. Lens frame 2 is preferably made of plastic but other materials, such as metal or titanium, may be used as desired by one of skill in the art.

Eyewear 1 has a pair of arms 6 and 8 attached to opposite ends 10 and 12 of the lens frame 2. Arms 6 and 8 are preferably made of plastic, but any other material, such as metal or titanium, may be used as desired by one of skill in the art. Each arm 6 and 8 has an end portion 14 and 16. Each end portion 14 and 16 has an aperture 18 configured to secure eyewear 1 to button 20 of clothing 26 (best seen in FIG. 4).

Referring now to FIGS. 2-4, in the preferred embodiment, aperture 18 is tear-shaped, but any other shaped aperture that will secure eyewear 1 to button 20 of clothing 26 may be used as desired by one of skill in the art. Aperture 18 of eyewear 1 is configured to receive a button 20 sewn to clothing 26. In the preferred embodiment, aperture 18 has a thread retaining portion 22 and a button insertion portion 24. Button insertion portion 24 is opposite thread retaining portion 22. Button insertion portion 24 is configured to allow the insertion of button 20 of clothing 26, such as a shirt or blouse. (See FIG. 4).

To secure eyewear 1 to a button 20 of clothing 26, arms 6 and 8 are folded in towards the opposite ends of lens frame 2. Button 20 is inserted into the button insertion portion 24 of aperture 18. Once button 20 is inserted into button insertion portion 24 of aperture 18, the bundle of threads (not shown) attaching button 20 to clothing 26 slide into the thread retaining portion 22 of aperture 18 securing eyewear 1 to button 20 of clothing 26.

Although the foregoing invention has been described in some detail by way of illustration and example for purposes of clarity of understanding, it will be obvious that certain changes and modifications can be made which are within the full scope of the invention. Further aspects of the invention are the subject matter of further dependent claims.

I claim:

1. Eyewear comprising:
(a) a lens frame configured to accommodate lenses; and
(b) a pair of arms, wherein each arm is attached to opposite ends of said lens frame, wherein each said arm includes an end portion configured to secure said lens frame to a wearer of said eyewear, said end portion having an aperture, wherein said aperture is tear-shaped.

2. The eyewear of claim 1 wherein said aperture is configured to receive a button attached to clothing.

3. The eyewear of claim 1 wherein said tear-shaped aperture comprises:
(a) a thread retaining portion, and
(b) a button insertion portion, wherein said button insertion portion is opposite said thread retaining portion.

4. The eyewear of claim 3 wherein the thread retaining portion has a diameter of at least one millimeter.

5. The eyewear of claim 3 wherein the button insertion portion has a diameter of at least one centimeter.

6. A method to attach eyewear to a button attached to clothing by a bundle of threads, wherein said eyewear comprises (a) a lens frame configured to accommodate lenses and (b) a pair of arms, wherein each arm is attached to opposite ends of said lens frame, wherein each said arm includes an end portion configured to secure said lens frame to a wearer of said eyewear, said end portion having an aperture, wherein said aperture is tear-shaped, wherein said aperture comprises a thread retaining portion and a button insertion portion, wherein said button insertion portion is opposite said thread retaining portion, said method comprising:
(a) folding said pair of arms in towards the opposite ends of said lens frame;
(b) inserting said button attached to clothing into the button insertion portion of said aperture; and
(c) allowing said bundle of threads attaching button to clothing to slide into the thread retaining portion of said aperture.
